(19) United States
(12) Patent Application Publication
(10) Pub. No.: US 2025/0357706 A1
(43) Pub. Date: Nov. 20, 2025

(54) SHIELDED PLUG CONNECTOR HOUSING

(71) Applicant: HARTING Electric Stiftung & Co. KG, Espelkamp (DE)

(72) Inventor: Daniel WESSELER, Georgsmarienhuette (DE)

(21) Appl. No.: 18/871,428

(22) PCT Filed: May 23, 2023
(86) PCT No.: PCT/DE2023/100381

§ 371 Date: Dec. 3, 2024

(30) Foreign Application Priority Data
Jun. 3, 2022 (DE) 10 2022 114 059.8

(51) Int. Cl. H01R 13/6581; H01R 43/18

(52) U.S. Cl. CPC H01R 13/6581; H01R 43/18

(57) ABSTRACT

Disclosed is a plug connector housing, which is formed from an at least partially open-pore, electrically conductive housing body, through at least part of which a non-conductive plastic material passes, and a plug connector that uses such a plug connector housing. Also disclosed is a method for producing a plug connector, wherein an open-pore, metal housing body is produced in a casting method or a sintering process, wherein the housing body is inserted in an injection molding tool, wherein in the injection molding process the outside of the housing body is encased with a plastic material at least in some regions, wherein plastic material also enters the open pores and the interior of the housing body.

### DESCRIPTION OF THE INVENTION

The invention is based on a plug connector housing and to a plug connector comprising such a plug connector housing and an insulating body, and to a method for producing a plug connector.

Plug connector housings accommodate in particular the contact elements of plug connectors. They are used in a wide variety of fields of use and must therefore meet a wide variety of requirements. The plug connector housing according to the invention is used in particular to electromagnetically shield the housing interior and thereby ensure improved signal integrity of such a plug connector.

The quality of such electromagnetic shielding is usually ascertained by a transfer impedance measurement (also referred to as coupling resistance). The lower the transfer impedance is, the higher the shielding effect of the plug connector housing.

### BACKGROUND OF THE INVENTION

Plug connector housings with a uniform material composition are known from the prior art. It is common for parts of the surface of the plug connector housing to be overmolded with a plastics material. This plastics part, however, only fulfils haptic or sealing tasks and is not an integral component of the plug connector housing. DE 20 2011 105 009 U1 discloses a metallic plug connector housing and DE 20 2010 002 396 U1 discloses a plug connector housing made of plastic.

Both materials (plastic and metal) have advantages and disadvantages. The housing materials are chosen depending on the task and field of use of a plug connector.

DE 10 2012 102 275 A1 discloses a plug connector housing of which the main body consists of metal, which is coated with a plastics material.

In the case of this plug connector housing, the metal component forms a foundation for the plug connector housing, while the plastics component is only added for sealing reasons.

In the priority application relating to the present application, the German Patent and Trade Mark Office conducted a search in respect of the following prior art:

US 2019/0 146 169 A1 and U.S. Pat. No. 4,713,277 A.

### SUMMARY OF THE INVENTION

The object of the invention is to provide a plug connector housing which is lightweight and at the same time offers a high degree of EMC shielding. It should also be possible to produce the plug connector housing inexpensively.

The plug connector housing has an at least partially open-celled, electrically conductive housing body.

The housing body has for example the shape of a hollow cuboid or a hollow cylinder. An open plug side and an open cable outlet are already formed on the housing body.

An open-celled nature within the meaning of the invention is present when, in the wall of the housing body, an outer opening and an inner opening are connected to one another via a cavity. The connection between the two openings could also be referred to as passage or duct instead of cavity.

The open-celled nature is obtained for example by the use of porous metals or metal foams. A solid metallic housing body could also be provided with fine bores, in order to achieve comparable properties. Such a housing body would, however, be too complex and thus expensive to produce.

The cell distribution can be influenced, or adjusted, by the production process for the housing body. The production method for the plug connector housing is explained in more detail later on. A suitable cell distribution makes it possible to have a positive influence on the electromagnetic shielding properties of the plug connector housing, compared to a cell-free material of the same material thickness. Similarly, a suitable cell distribution makes it possible to achieve a high level of overvoltage protection.

The plug connector housing according to the invention is at least partially traversed by a non-conductive plastics material. In this respect, in particular liquid or viscous media, such as plasticized polymer, flows through the cells.

The housing body is preferably externally encased by the plastics material. In addition or alternatively, the housing body is internally encased by the plastics material. Encased means that plastics material is formed extensively over the surface of the housing body and held thereon, and/or connected thereto. The housing body may also be traversed by the plastics material owing to the open- celled nature.

On the outside, the plastics material forms the outer skin of the plug connector housing. The outer skin is closed, in order to prevent the ingress of foreign media, for example fluids and/or dust. The outer skin may additionally have channels and/or grooves on certain regions, in order to improve the haptics of the plug connector housing.

The housing body may consist of a conductive plastic. Preferably, however, the housing body is formed from an open-celled metal foam.

As already mentioned above, the open-celled nature can be described by a multiplicity of cells in the housing body, wherein multiple cells each have a cavity which has both an opening on the outside and on the inside of the housing body. The housing wall of the housing body thus has cavities through which material can pass from the outside to the inside, and vice versa.

The aforementioned cavity, or the hollow spaces, in the housing body are filled with plastics material. To this end, a polymer is externally applied under a certain pressure to the housing body, for example in an injection molding method. In the process, the polymer enters the cavities, or hollow spaces, in the housing body and thus also enters the interior of the housing body. It is also conceivable to carry out an injection molding method from the inside of the housing body. In this case, pressure is applied to a polymer from the inside of the housing body, so that the polymer passes through said cavities to the outside.

A plug connector according to the invention consists of a plug connector housing as described above and an insulating body. In this case, the insulating body is fusion bonded to the plastics material of the plug connector housing or completely encased by this plastics material or formed from this plastics material. Apart from the plug connector housing, all the components necessary for the plug connector are placed into an injection mold. This makes it possible to produce such a plug connector in few work steps.

The plug connector housing according to the invention is produced as follows: Firstly, an open-celled, metallic housing body is produced by casting or in a sintering process. The semifinished product (housing body) produced in this way is then inserted into an injection molding tool and a plasticized polymer is externally applied to it therein.

The polymer encloses the housing body at least in certain regions. In the process, the polymer also penetrates the open cells and the interior of the housing body through the cells. The housing body is externally encased and enters the interior of the housing body through the open cells. The polymer hardens and forms a plastic.

The housing body and contact elements arranged therein are preferably inserted into the injection molding tool. Then, an insulating body encompassing, or enclosing, the electrical contact elements could be formed in the injection molding process set out above. The overmolding and the insulating body are accordingly produced in one injection cycle.

Such a method makes it possible to produce a plug connector, in particular an electromagnetically shielded plug connector, very quickly and in few method steps. The basis for this is the use of an open-celled material, which forms said main body. The material can be penetrated by liquid, or viscous, media such as plasticized plastics. The cell distribution of the material also ensures improved EMC shielding compared to correspondingly cell-free materials.

As an alternative, an insulating body for contact elements can be inserted into the injection molding tool. The insulating body is then in turn arranged inside the housing body. In the injection molding process, the insulating body may be encased by and/or fusion bonded to the plastics material at least in certain regions. Contact elements are then preferably already arranged in the insulating body.

The aforementioned contact elements are preferably already electrically conductively connected to wires of a multi-core cable. In this case, after the injection molding process the result would be a finished plug connector with attached cable.

In this case, a suitable cable strain relief means on the housing body and cables and/or cable sheaths can also be integrally molded directly at a cable outlet in the injection molding process.

### BRIEF DESCRIPTION OF THE DRAWINGS

An exemplary embodiment of the invention is illustrated in the drawings and will be explained in more detail below. In the figures:

FIG. 1 shows a perspective illustration of a main body of a plug connector housing according to the invention,

FIG. 2 shows a perspective illustration of a main body with a fixing sleeve arranged on the plug side,

FIG. 3 shows a perspective illustration of a plug connector, which is equipped with a plug connector housing according to the invention,

FIG. 4 shows a further perspective illustration of the plug connector, which is equipped with a plug connector housing according to the invention and

FIG. 5 shows a perspective sectional illustration of the plug connector housing according to the invention.

### DETAILED DESCRIPTION OF THE INVENTION

The figures contain partially simplified, schematic illustrations. To some extent, identical reference signs are used for elements that are similar but might not be identical. Different views of the same elements may be drawn to different scales. Directional indications such as “left”, “right”, “top” and “bottom” should be understood with reference to the figure in question and may vary in the individual illustrations in relation to the object illustrated.

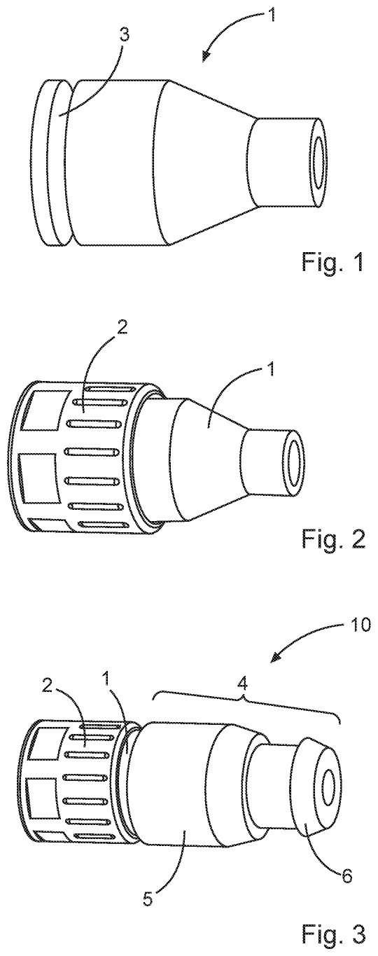

FIG. 1 shows an open-celled housing body 1, which consists of an electrically conductive material, in particular of metallic material. Open-celled in the present patent application is understood to mean that the housing wall of the housing body has a cavity (which can also be referred to as duct or passage), which connects an opening on the outside of the housing body to an opening inside the housing body. The openings and the associated cavity must be configured such that a plastic that has been liquefied for an injection molding process can enter the interior of the housing body through the cavity via the external opening.

The housing body 1 consists of an electrically conductive material, for example a metal. For example, a foamed metal material can be used.

The housing body 1 has substantially the shape of a hollow cylinder, the diameter of which tapers on the cable connection side. On the plug side, the housing body 1 has an encircling groove 3.

In the exemplary embodiment shown here, a locking sleeve 2 is latched onto it. The locking sleeve 2 can be pulled forward and back along the main axis of symmetry of the housing body 1, such that what is referred to as a push-pull locking arrangement with a mating plug connector (not shown) can be established. The locking sleeve 2 may also be in the form of what is referred to as a knurled screw and establish a corresponding screwed connection with a mating plug connector or a socket.

The housing body 1 is placed into an injection mold (not shown). Thermoplastic materials are generally used in injection molding. Such plastics are liquefied by heating and resolidify as they cool. In this case, a liquefied plastic is applied to the housing body 1 in certain regions. In the process, the housing body 1 is also traversed by the non-conductive plastics material 4.

FIG. 3 shows, in perspective, a plug connector housing according to the invention. In this illustration, the viewing direction is directed at the cable connection side of the plug connector housing 10. Here, the plastics material 4 forms a plastics sheath 5, which covers the housing body 1 in certain regions. The plastics sheath 5 thus substantially constitutes the plug connector housing sheath. Furthermore, the plastics material 4 at the cable outlet forms a strain relief means 6 for an attached cable (not shown). In this case, the cable is also placed into the injection mold and encompassed, or enclosed, by the plastics material. In the process, the cable sheath of the cable is optionally briefly melted and fused with the injected plastics material 4.

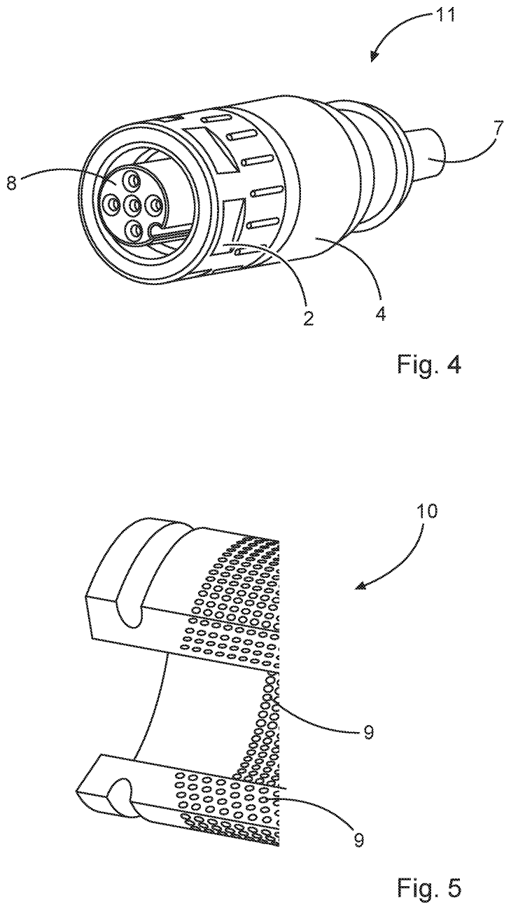

FIG. 4 shows the perspective illustration of a plug connector 11, which has a plug connector housing 10. In this illustration, the viewing direction is directed at the mating face of the plug connector 11. The plug connector 11 is fitted with an insulating body 8, in which the contact elements (which are not shown for representational reasons) are arranged. The contact elements are each electrically conductively connected to individual electrical wires (not shown) of a multi-core cable 7.

The insulating body 8 is fusion bonded to the plastics material 4 of the plug connector housing 10. During the injection molding process, the plastics material of the insulating body is slightly melted on the surface, with the result that the plastics material 4 can enter into what is referred to as an interlocking fusion bond. As an alternative, the insulating body 8 may also be encased completely by the plastics material 4. In a further alternative variant, the insulating body 8 is formed from the plastics material 4.

FIG. 5 illustrates a detail, in perspective and in section, of a plug connector housing 10. It can be seen here that the open-celled nature of the plug connector housing 10 is formed by a multiplicity of cells 9 of the housing body 1. The cells 9 have a cavity (duct or passage), which has both an opening on the outside and on the inside of the housing body 1. As a result, during the injection molding method described above, liquid plastics material, which acts on the outside of the housing body 1, can enter the interior of the housing body 1. The connected cable 7 can be fusion bonded to or encased by the plastics material 4 analogously to the insulating body.

### LIST OF REFERENCE SIGNS

1 Housing body
2 Locking sleeve
3 Encircling groove
4 Plastics material
5 Housing sheath
6 Strain relief means
7 Cable
8 Insulating body
9 Cell
10 Plug connector housing
11 Plug connector

1. A plug connector housing, which is formed from an at least partially open-celled, electrically conductive housing body, which is at least partially traversed by a non-conductive plastics material.

2. The plug connector housing as claimed in claim 1, wherein
the housing body is externally encased by the plastics material at least in certain regions and/or the housing body is internally encased by the plastics material at least in certain regions.

3. The plug connector housing as claimed in claim 1, wherein
the housing body is made of an open-cell metal foam or a sintering material.

4. The plug connector housing as claimed in claim 2, wherein
the open-celled nature is formed by a multiplicity of cells in the housing body, wherein multiple cells have a cavity which has both an opening on the outside and on the inside of the housing body

5. The plug connector housing as claimed in claim 4, wherein
the cavity is filled with plastics material.

6. A plug connector consisting of a plug connector housing as claimed in claim 1 and an insulating body, which is fusion bonded to the plastics material or completely encased by the plastics material or formed from the plastics material.

7. A method for producing a plug connector, wherein an open-celled, metallic housing body is inserted into an injection molding tool, wherein in the injection molding process, the housing body is externally encased with a plastics material at least in certain regions, wherein plastics material also enters the open cells and the interior of the housing body.

8. The method for producing a plug connector, wherein
the housing body is produced by casting or in a sintering process.

9. The method as claimed in claim 7, wherein
in that contact elements are inserted into the injection molding tool, wherein the contact elements are arranged inside the housing body or in that an insulating body for contact elements is inserted into the injection molding tool.

10. The method as claimed in claim 9, wherein
in the injection molding process, an insulating body comprising the electrical contact elements is formed or in that in the injection molding process, the insulating body is encased by and/or fusion bonded to the plastics material at least in certain regions.

11. The plug connector housing as claimed in claim 3, wherein
the open-celled nature is formed by a multiplicity of cells in the housing body, wherein multiple cells have a cavity which has both an opening on the outside and on the inside of the housing body.

12. The plug connector housing as claimed in claim 11, wherein
the cavity is filled with plastics material.

13. The method as claimed in claim 7, wherein
in that contact elements are inserted into the injection molding tool, wherein the contact elements are arranged inside the housing body or in that an insulating body for contact elements is inserted into the injection molding tool.

14. The method as claimed in claim 13, wherein in the injection molding process, an insulating body comprising the electrical contact elements is formed or in that in the injection molding process, the insulating body is encased by and/or fusion bonded to the plastics material at least in certain regions.

15. The method as claimed in claim 8, wherein
in that contact elements are inserted into the injection molding tool, wherein the contact elements are arranged inside the housing body or in that an insulating body for contact elements is inserted into the injection molding tool.

16. The method as claimed in claim 15, wherein
in the injection molding process, an insulating body comprising the electrical contact elements is formed or in that in the injection molding process, the insulating body is encased by and/or fusion bonded to the plastics material at least in certain regions.
